(19) United States
(12) Patent Application Publication
(10) Pub. No.: US 2008/0255863 A1
(43) Pub. Date: Oct. 16, 2008

(54) METHOD AND COMPUTER PROGRAM PRODUCT FOR PROVIDING PAPERLESS CUSTOMS DOCUMENTATION

(75) Inventors: Dennis Mack, Roswell, GA (US); Joe Johnson, Worcester, MA (US); Paul Reithmeier, Morristown, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/734,543

(22) Filed: Apr. 12, 2007

(51) Int. Cl. G06Q 50/00; B41M 99/00; G06K 9/00

(52) U.S. Cl. 705/1; 101/483; 382/101

(57) ABSTRACT

A method and computer program product for providing paperless customs documentation associated with an international parcel shipment. In various embodiments, the method comprises storing shipping data associated with a parcel shipment, the shipping data designating a destination country and including invoice data, verifying that the destination country accepts electronic customs documentation, and creating an electronic invoice from the shipping data. In various embodiments, the electronic invoice may be easily accessed, such as being transmitted over a network or stored in an RFID transponder associated with the parcel shipment. As a result, the present invention reduces the costs and shipping times associated with preparing, processing, and receiving international shipments by determining whether a country accepts paperless customs documentation and, if so, providing a variety of functions that streamline the international shipping process.

### FIELD OF THE INVENTION

In general, embodiments of the present invention relate to international shipping functions, and, in particular, to providing customs documentation associated with international parcel shipments.

### BACKGROUND OF THE INVENTION

The international supply chain of goods has been spurred on by, among other things, trade globalization and modern manufacturing processes. These have allowed many businesses to become involved in the international supply chain of goods. A given manufacturer frequently obtains assembly components from suppliers located in various countries and each of the suppliers, in turn, may obtain subcomponents from suppliers in other countries, and so on. It is the norm that products may have subcomponents made in various countries. Coupled with the prevalence of ‘just-in-time’ inventory management, timely international shipping of parts is a critical aspect of maintaining orderly and efficient supply chain management. Facilitating importation of such shipments is critical to modern manufacturing processes and providing an efficient global trade economy.

However, importing goods of a shipment is a complicated process involving many regulations that vary from country to country. Most countries have adopted an international goods classification scheme for categorizing goods. The scheme provides a classification number along with a description of the goods. The importing country assigns a duty rate based on the classification of the goods. Thus, the duty rate in conjunction with the value of the goods (and other factors) allows calculation of the duties and taxes to be paid to customs for the imported goods. Additionally, many countries restrict the type of goods that can be imported under the auspices of international trade agreements or unilateral regulation by the importing country. Special permits may be required for importing particular goods to a particular consignee. Finally, each country has different documentation requirements that must be met. In particular, many countries have specific requirements relating to the commercial invoice associated with a particular shipment.

Once a shipment has been rated (and assuming none of the items are restricted from importation), required duties and tariffs must be paid to the appropriate governmental agency, typically a customs office. The carrier typically communicates information regarding the shipment, including an international commercial shipping invoice, to a customs broker. Importing agents typically review documentation associated with the shipment and verify the amount due. Once the amount due is collected by the customs office and the importing agents have reviewed the appropriate documentation, the customs office issues a “customs clearance” to the carrier indicating that delivery to the consignee may proceed. Usually, if goods have arrived at that importing port or terminal, the imported goods are temporarily stored until clearance is obtained, and then local delivery of the goods continues. To minimize storage costs and delays, it is desirable to provide accurate and complete information to the Customs Office to facilitate a timely clearance response for a shipment.

For the carrier(s) shipping the goods, the myriad regulations, which also vary from country to country, present a complicated logistics operation that benefits from the application of computer systems. Specialized customs brokerage agents exist in various countries to facilitate importation of goods and these agents may use computerized systems to assist them. As the need and scope of international shipping increases, the desire to further reduce costs, minimize delays, and speed up delivery times becomes more significant. An increasing number of countries have modified their commercial invoice requirements to take advantage of the speed and convenience that computer systems and corresponding paperless records allow. And this trend is expected to continue.

Most shipping entities, however, create original signed paper invoices that are physically attached to a parcel shipment. For those countries that accept electronic copies of an invoice, preparing and processing a shipment with a printed invoice increases overall costs and shipping times. Because the shipping entity (shipper) must create a physical invoice and attach it to the parcel shipment, this increases the time and costs associated with preparing the international parcel shipment. Because a shipping service provider must locate the physical invoice on the parcel, remove and inspect the invoice, and (in some cases) enter data from the invoice, this increases the time and costs associated with processing the international shipment. Finally, because a customs broker must also locate and inspect the physical invoice, this increases the time and costs associated with receiving the incoming shipments.

As a result, there is a need for a method and computer program product for providing paperless customs documentations. The method and computer program product should aid in decreasing the costs and shipping times associated with preparing, processing, and receiving international shipments.

### BRIEF SUMMARY OF THE INVENTION

Exemplary embodiments of the present invention provide an improvement over the known prior art by, among other things, describing a method and computer program product for providing paperless customs documentation associated with an international parcel shipment. The present invention reduces the costs and shipping times associated with preparing, processing, and receiving international shipments by determining whether a destination country accepts paperless customs documentation and, if so, providing a variety of functions that streamline the international shipping process.

In one embodiment, the present invention provides a method of providing paperless customs documentation associated with an international parcel shipment comprising storing shipping data associated with the parcel shipment, the shipping data designating a destination country and including invoice data, verifying that the destination country accepts electronic customs documentation, and creating an electronic invoice from the shipping data. Another embodiment further comprises transferring the electronic invoice over a network to a distribution center. Another embodiment further comprises creating a reference number associated with the parcel shipment. Another embodiment further comprises transferring the electronic invoice over a network to a third party, wherein the third party validates the electronic invoice. In another embodiment, the step of creating an electronic invoice comprises transferring the shipping data over a network to a shipping service provider and wherein the shipping service provider coverts the shipping data into the electronic invoice. In another embodiment, the step of creating an electronic invoice comprises transferring the shipping data over a network to a third party, and wherein the third party converts the shipping data into the electronic invoice. Another embodiment further comprises storing the electronic invoice on a database accessible over the network. Another embodiment further comprises creating an electronic record that includes an image of the electronic invoice, the electronic record having an associated filename that incorporates at least a portion of the reference number, and wherein the step of transferring the electronic invoice comprises transferring the electronic record. Another embodiment further comprises generating a printed label associated with the parcel shipment. In another embodiment, the printed label includes a readable indicator indicating that an electronic invoice is associated with the international parcel shipment. The readable indicator may be a visual indicator and/or a machine readable indicator. In other embodiments, a machine readable indicator may be readable by at least one of barcode reader, a MaxiCode reader, a PDF417 reader, or an RFID reader. And in another embodiment, the electronic invoice is stored on an RFID transponder associated with the parcel shipment.

In addition to the exemplary embodiments relating to methods of providing paperless customs documentation associated with an international parcel shipment, the present invention also provides exemplary embodiments relating to computer program products for providing paperless customs documentation associated with an international parcel shipment as similarly described above.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of a network environment configured for providing paperless customs documentation associated with an international parcel shipment in accordance with one exemplary embodiment of the present invention;

FIG. 2 is a flowchart showing steps typically required for creating and auditing international shipping invoices in accordance with one procedure of the prior art;

FIG. 3 is flowchart showing steps typically required for creating and auditing international shipping invoices in accordance with another procedure of the prior art;

FIG. 4 is flowchart showing steps for providing paperless customs documentation associated with an international parcel shipment in accordance with one exemplary embodiment of the present invention;

FIG. 5 shows an example of a shipping label associated with an international parcel shipment having paperless customs documentation in accordance with one embodiment of the present invention; and

FIG. 6 is a block diagram of an exemplary electronic device configured to execute a method of providing paperless customs documentation associated with an international parcel shipment in accordance with one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Shipping service providers (e.g., carriers, parcel delivery companies, etc.) have developed shipping software for shipping entities (e.g., carrier customers) allowing the shipping entities to enter their shipping records into personal computers, from where the records are uploaded to the carrier's computer system. Accordingly, the shipping records no longer need to be manually keyed into the delivery company's computer system. Further, the shipping software prints machine readable parcel labels that allow the parcels to be machine sorted, which is both more efficient and more accurate. Thus, the shipping software, along with the tracking software, permits parcel delivery companies to provide shipping customers with improved, more efficient service.

These shipping systems typically prompt, accept, and verify invoice data provided by the shipping customer, write the invoice data to a file, and then transmit the file to a second computer, such as a server, operated by the carrier. The data transmitted typically also includes a reference or tracking number. In various embodiments, the tracking number may include an indicium identifying the number as a tracking number, a customer account number, a level of service indicator corresponding to the level of service indicated in the level of service indicating region, and a predetermined reference number determined by the shipping service provider. The customer account number may include payment indicia corresponding to a type of payment by a customer of the carrier for shipment of the package, the payment indicia corresponding, for example, to a pre-established account of the customer with the carrier, or a credit card payment.

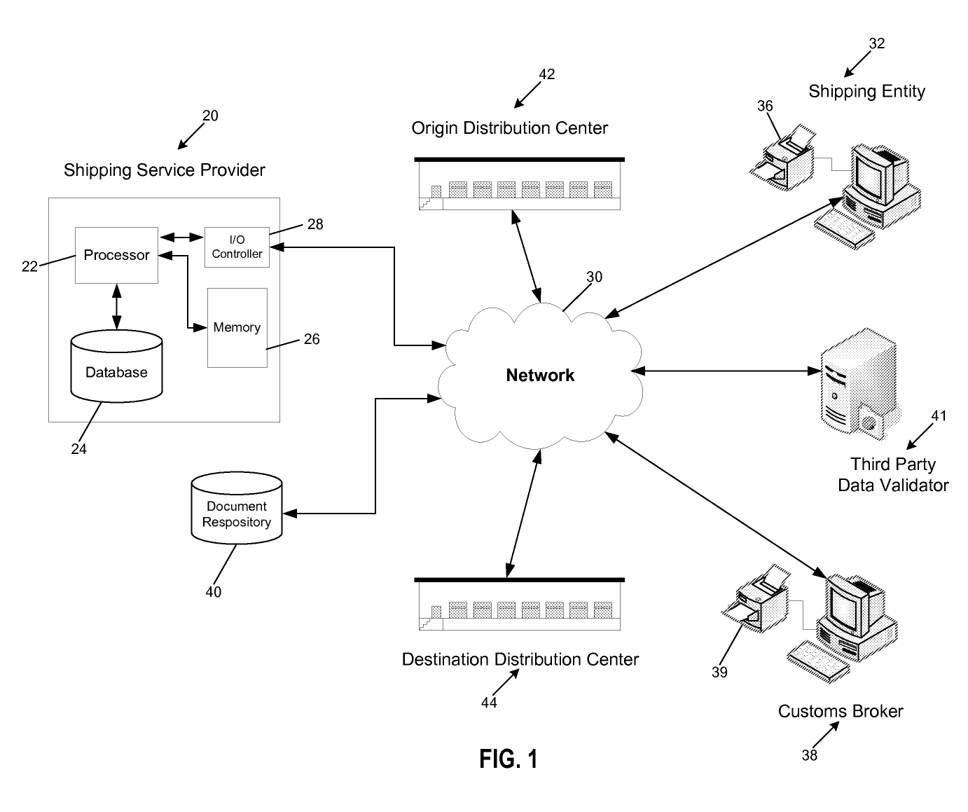

Referring to FIG. 1, the shipping system functions as a local shipping system relative to the user and remote relative to a server operated by the carrier. In this embodiment, a server 20, is typically operated by the shipping service provider and communicates with a shipping entity system 32. Although only one shipping entity system 32 is shown, typically there are many shipping entities associated with various users (such as other customers of the shipping service provider) that can communicate with the shipping service provider's server 20. The server 20 typically comprises a processor 22 that communicates with a database 24, which can be viewed as a form of secondary memory, as well as primary memory 26. The processor also communicates with external devices using an I/O controller 28 that typically interfaces with a network 30. In various embodiments, the network 30 may a LAN, a WAN, the Internet, etc. The network may also provide local connectivity between a printer 36 and the shipping entity system 32. Communication between the server 20 and the shipping entity system 32 typically is accomplished by routing data through the network 30. The shipping entity system 32 may interact with the server 20 in a client-server manner in which the shipping entity system 32 executes a web-based browser. Alternatively, the shipping entity system 32 may interact with the server on a peer-to-peer or master-slave basis. An example of a shipping system as described above is the UPS WorldShip™ software solution.

Other entities, systems, and/or devices may also interact with the network 30 in accordance with various embodiments of the present invention. For example, a customs broker's system 38 may interact with the network 30 so as to have access to the shipping service provider server 20 and/or any document repository 40 that may be connected to the network 30. A third party data validator 41 may also interact with the network 40, as well as one or more distribution centers associated with the shipping service provider. In the embodiment depicted in FIG. 1, an origin distribution center 42 and a destination distribution center 44 are shown.

It should be noted that those skilled in the art of data networking will realize that many other alternatives and architectures are possible that can be used to practice the principles of the present invention. The embodiments illustrated in FIG. 1 can be modified to use other technologies and still be within the scope of the present invention as claimed.

As noted above, an increasing number of countries have modified their commercial invoice requirements to take advantage of the speed and convenience that computer systems and corresponding paperless records allow. Most shipping entities, however, continue to spend time and money creating original signed paper invoices that are physically attached to a parcel shipment. For those countries that accept electronic customs documentation, preparing and processing a shipment with a printed invoice slows down processing time and increases the costs associated with the parcel shipment. Because the shipping entity must create a physical invoice and attach it to the parcel shipment, this increases the processing and handling times and costs associated with preparing and shipping an international parcel shipment.

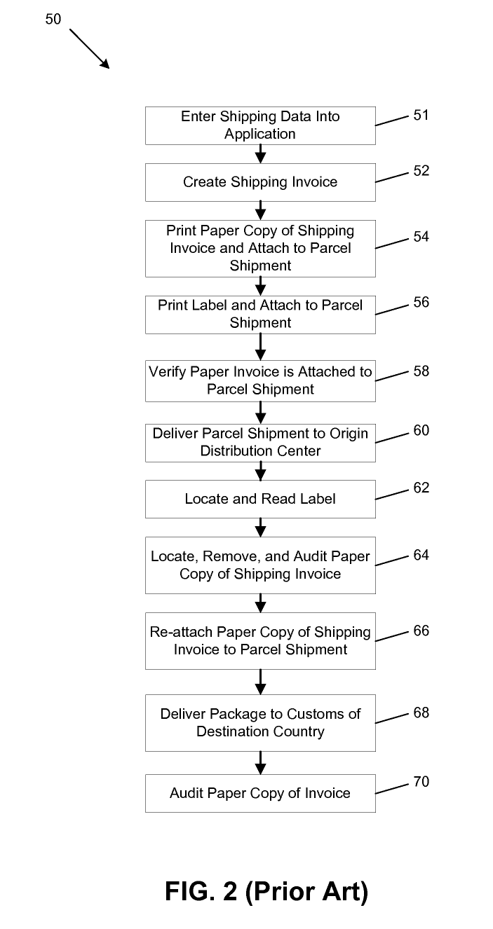

FIG. 2 is a flowchart showing steps typically required for creation and auditing of international shipping invoices associated with an international parcel shipment in accordance with one procedure 50 of the prior art. According to some prior art practices, despite the fact that the destination country may be one that would accept paperless customs documentation, many shippers create a paper copy of an international shipping invoice that is then attached to the parcel shipment. Referring to the figure, in block 51, a shipping entity typically enters shipping data into an application such as a software application designed to facilitate the creation of customs documentation associated with an international parcel shipment. In block 52, a shipping invoice is created based on the shipping data provided by the shipping entity. In some cases, the shipping invoice may be generated by hand (in which case block 51 is unnecessary), in others, the application may aid in creating the shipping invoice. It should be noted that many countries have various requirements regarding information that should be included on an international shipping invoice. In many instances, this information includes providing the shipping entity's letterhead and/or logo, a description of the goods, a unit value of the goods, a total value of the goods, and a shipping signature. In block 54, a paper copy of the shipping invoice is printed and attached to the parcel shipment. In many instances the paper copy of the shipping invoice is folded and placed into a pouch that is attached to the outside of the parcel shipment package. If there are multiple packages associated with the parcel shipment, the invoice may be attached to a lead package.

In block 56 the shipping entity prints a label (or labels depending on the number of packages) associated with the parcel shipment. The label is then attached to the package. The label typically includes information about the parcel shipment including the shipping entity's address, the recipient's address, a tracking number, and one or more machine readable codes that carry information relating to the parcel shipment. The tracking number uniquely identifies one package from others in the shipping service provider's system. As used by the assignee of the present application, the tracking number often consists of a series of alphanumeric characters that uniquely identify each package in the package transportation system. In most cases, the tracking number is affixed to the package in the form of a machine readable code or symbol such as a bar code. The machine readable code may be read by electronic code readers at various points in the transportation system. This allows the shipping service provider to monitor the movement of each package through its system and to provide customers with information pertaining to the status and location of each package.

Before the parcel shipment package leaves the shipping entity in the prior art process, in block 58 the shipping entity must verify that a paper invoice is attached to the package of the parcel shipment. Without another method of creating a shipping invoice, the shipping service provider will need to locate and ensure that a shipping invoice is attached to the parcel shipment before forwarding the parcel shipment to the shipping service provider. In block 60, the parcel shipment is delivered to an origin distribution center or hub. Distribution centers are preferably, but not always, centrally located in a geographic region to allow distribution of packages to a plurality of locations disposed throughout the region. Depending on the size of the region and the immediacy of delivery, a shipping service provider may have one or many distribution centers spread across a given geographic region. In the business of shipping packages internationally, shipping service providers may have distribution centers located in various regions of the world.

Typically, packages arrive at distribution centers in groups sharing common sources and leave in groups sharing common destinations. Thus, shipments of common-source packages must be efficiently sorted into shipments of common-destination packages. In block 62, at the origin distribution center, the shipping label of the package is located and read. This may be done visually or using any machine readable code that may be on the label. In many known sorting systems, a shipment of packages arrives at a distribution center, usually by truck. The packages are unloaded from the truck onto a feed conveyor which transports the packages to a worker who sorts them. This sorter reads the zip code of the destination address of each package as it arrives at the end of the feed conveyor. The sorter also determines the appropriate zip code category corresponding to the zip code of each package.

In block 64 of the prior art process, the paper shipping invoice must be located, removed, and audited at the origin distribution center to determine whether the shipping invoice includes all of the information required by the destination country. In block 66, the shipping invoice must then be re-attached to the package. After reading the shipping label and sorting the package, in block 68 the package is then delivered to a customs office of the destination country. Once at the customs office, in block 70 the paper copy of the shipping invoice must be located on the package, removed, and audited for compliance with the destination country's requirements.

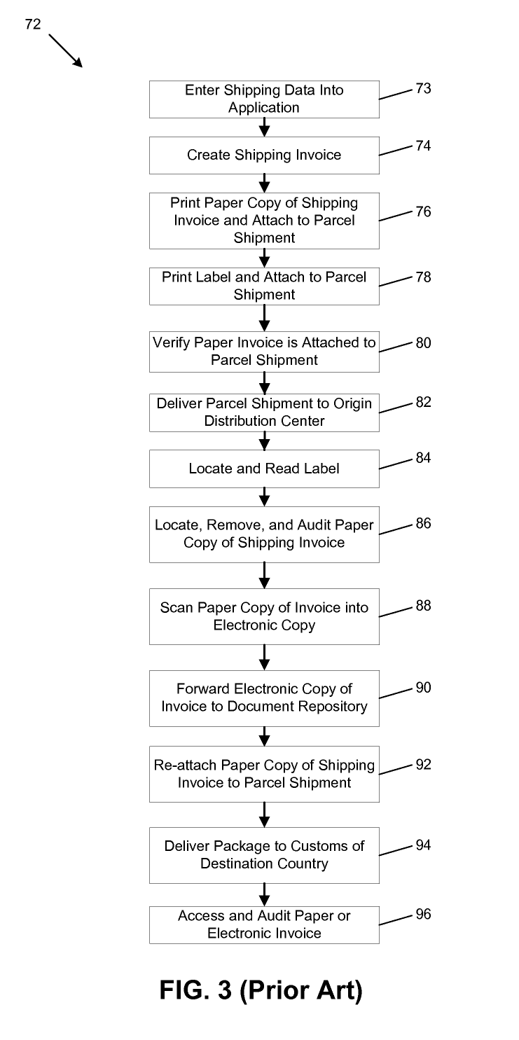

FIG. 3 is a flowchart showing steps typically required for creation and auditing of international shipping invoices associated with an international parcel shipment in accordance with another procedure 72 of the prior art. In this procedure, an electronic copy of a paper shipping invoice is created by the shipping service provider for those destination countries that permit electronic invoices. As with the prior art procedure described above, in block 73 a shipping entity typically enters shipping data into an application. In block 74, a shipping invoice is created based on the shipping data provided by the shipping entity. In block 76, a paper copy of the shipping invoice is printed and attached to the parcel shipment. In block 78, the shipping entity prints a label (or labels depending on the number of packages in the parcel shipment) associated with the parcel shipment. The label is then attached to the package. In block 80 the shipping entity must verify that a paper invoice is attached to the package of the parcel shipment. In block 82, the parcel shipment is delivered to an origin distribution center or hub. In block 84, the shipping label of the package is located and read. As with the above prior art procedure, this may be done visually or using any machine readable code that may be on the label. In block 86, the paper shipping invoice must be located, removed, and audited at the origin distribution center to determine whether the shipping invoice includes all of the information required by the destination country.

Unlike the prior art procedure above, in block 88 of this prior art procedure, the shipping service provider creates an electronic copy of the paper shipping invoice. This is typically accomplished by scanning the paper invoice into an electronic file format (e.g, PDF or TIFF format). In block 90, the electronic copy of the shipping invoice is then forwarded over a network to a document repository, accessible by a customs broker. In block 92, the shipping invoice must then be re-attached to the package. In block 94, the package is then delivered to a customs office of the destination country. Once at the customs office, the paper copy of the shipping invoice must be located on the package removed, and audited for compliance with the destination country's requirements, if the destination county accepts electronic invoices, in block 96 a customs broker may access the electronic copy of the invoice in order to audit the invoice for compliance with the destination country's requirements.

As noted above, these prior art procedures increase overall costs and shipping times by unnecessarily requiring the shipping entity to create a paper invoice that must be tracked and audited as the package is shipped to the destination country. The present invention provides an improvement over the prior art by determining before a parcel shipment is shipped whether a country accepts paperless customs documentation and, if so, creating an electronic invoice associated with the parcel shipment. The electronic invoice of various embodiments of the present invention replaces a paper invoice and may be transferred with the parcel shipment electronically—thus streamlining the international shipping process.

Although not a limitation of the present invention, in various embodiments the creation of paperless invoices may be effected in connection with a contractual agreement between the shipping entity and the shipping service provider. Such an agreement may include instructions for the shipping entity to include specific details within the shipping data such that the shipping data may be used to create an international commercial shipping invoice in compliance with general customs requirements. For example, many countries may require a detailed description of the goods, a unit value of the goods, a total value of the goods, etc. Thus, a contractual agreement may include a provision requesting that the shipping entity enter accurate shipping data that complies with these requirements. Additionally, the contractual agreement may include a provision requesting that when paperless invoicing is desired, paper copies of the invoice should not be attached to the package of the parcel shipment, and if so, the paperless version of the invoice would take precedence. Provisions like these would help to further streamline the international shipping process using paperless invoicing by reducing non-compliant parcel shipments.

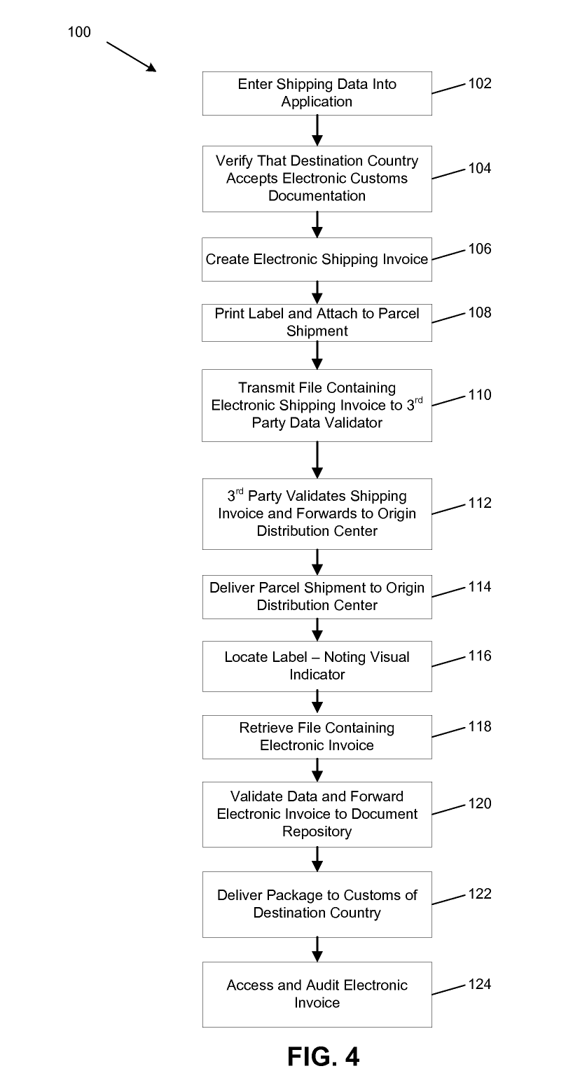

As shown in FIG. 1, one exemplary embodiment of the present invention may operate in an environment in which a shipping service provider server 20, a shipping entity system 32, a customs broker system 38, a document repository 40, a third party data validator 41, an origin distribution center 42, and a destination center 44 are configured to communicate over a network. Referring now to FIG. 4, a procedure 100 in accordance with an exemplary embodiment of the present invention may now be explained. In accordance with this embodiment, in block 102 shipping data may be entered into an application. Communication between the server (20 in FIG. 1) and the shipping entity system 32 is accomplished by routing data through the network 30. The shipping entity system 32 may interact with the server 20 in a client-server manner in which the shipping entity system 32 executes a web-based browser. Alternatively, the shipping entity system 32 may interact with the server on a peer-to-peer or master-slave basis. As noted, an example of a shipping system as described above is the UPS WorldShip™ software solution.

The shipping data of the exemplary embodiment designates a destination country and includes invoice data. In the exemplary embodiment, the invoice data is entered so as to be compliant with the international commercial shipping invoice requirements of the destination country, which, in various embodiments may be known and prompted for by the application. For example, the invoice data may include a detailed description of the goods, a unit value of the goods, a total value of the goods, etc. In the exemplary embodiment, in block 104 the application verifies that the destination country is a country that accepts electronic customs documentation. If the destination country is not a country that accepts electronic customs documentation, the shipping entity is advised through the application that a paper version of the international commercial shipping invoice should be created and attached to the package of the parcel shipment. The application may determine whether the destination country is a country that accepts electronic customs documentation in variety of ways, including, but not limited to, comparing the destination country designated in the shipping data with a database of countries that accept electronic customs documentation. In such an embodiment, the database may be periodically updated if or when additional countries indicate acceptance of electronic customs documentation. If the destination country is a country that accepts electronic customs documentation, in block 106 the application stores the shipping data and creates an electronic shipping invoice using the shipping data. An electronic shipping invoice may be created in a variety of ways, some of which are described in U.S. patent application Ser. No. ______ [TBD] the contents of which are hereby incorporated by reference. In other embodiments, the shipping data may be transmitted to the shipping service provider, who then creates the electronic shipping invoice.

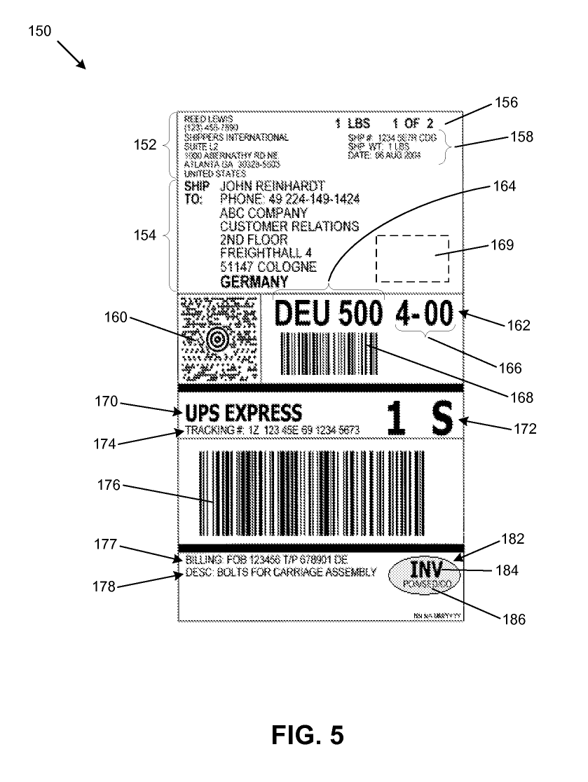

A reference number is also associated with the parcel shipment. The assignee of the present application often refers to this number as the tracking or “1Z” number. The tracking number uniquely identifies one package from others in the shipping service provider's system. In block 108, the shipping entity prints a shipping label that is attached to the package(s) of the parcel shipment. Although in various embodiments, a shipping label may have a variety of configurations, FIG. 5 shows a fictional shipping label in accordance with an exemplary embodiment of the present invention. A shipping label 150 generated in accordance with the exemplary embodiment of the present invention contains several information containing regions, some machine readable via bar code and/or Maxicode®, some human readable, and some security indicia. Information contained in the label is laid out to maximize use of space as well as machine readability. A return address region 152 appears in the upper left hand corner. Below the return address region 152 appears a ship to address region 154 and in the upper right hand corner appears a package count region 156 indicating how many packages are in the present shipment and the number of the present package within that shipment. Another shipping information region 158 may also be included for information relating to the shipping entity, package weight, and ship date information.

Below the ship to address region 154 is a square block containing a Maxicode® symbol 160. Maxicode® is a proprietary machine-readable dense code that may contain all the text of the label and optionally other invoice data relating to the parcel shipment. In various embodiments, the Maxicode® may also be used to store information relating to the electronic shipping invoice. Those skilled in the art will understand that a large amount of information can be stored in a Maxicode® and machine-read with a scanner. To the right of the Maxicode® is a human readable routing code 162, which identifies an origin distribution center 164 and a sorting belt code 166 which identifies the sorting belt within the hub 164 to which the package is first routed. An international postal barcode 168 appears below the human readable codes. In addition to, or in the place of, the barcode and MaxiCode symbols, the label 150 may include one or more radio frequency identification (RFID) transponders 169 capable of storing a variety of data, including, in some embodiments, electronic customs documentation. Additionally, although not shown in the figure, the label 150 may also include a PDF417 barcode that may include a variety of data relating to the package shipment, such as the shipping data (e.g. the package level detail).

Below the barcode 168 is service text 170 describing the level of the service and a large font alphanumeric level of service code 172. Below the service text 170 is the tracking number or 1Z code 174. In the exemplary embodiment, the tracking number comprises an alphanumeric 6-digit customer account number, a level of service identifier, a non-sequential reference numeral, and a check sum digit. The customer account number may contain a special character to designate a specific type of payment, for example, payment via the UPS flexible buying account, or payment using a credit card account. The tracking number may be encoded in a machine-readable barcode region 176, located below the tracking number 174. As noted above, a unique tracking number is generated for each label printed. In the lowermost section of the shipping label 150, an international billing option 177 expresses the type of billing. Below the international billing option 177 is a description of the goods 178.

For those parcel shipments that have electronic invoices, in accordance with various embodiments of the present invention, an electronic invoice indicator 182 is located on the shipping label. In the exemplary embodiment, the indicator 182 is a human readable indicator located at the bottom right-hand corner of the shipping label 150, however in other embodiments the indicator 182 may be a machine readable indicator or both a human readable indicator and a machine readable indicator. It should be noted that a human readable indicator in accordance with various embodiments of the present invention may be any symbol, or any combination of text, figures, symbols, colors, etc. configured to convey the existence of an associated electronic invoice. In the exemplary embodiment the electronic invoice indicator 182 is a yellow, oval-shaped icon that includes a large human readable text portion 184 indicating “INV”. Below the large text portion 184 is a smaller human readable text portion 186 that indicates the existence of other electronic customs documentation. In the exemplary embodiment, “POA” refers to the existence of an electronic international shipper's agreement, “SED” refers to the existence of an electronic shipper's export declaration, and “CO” refers the existence of an electronic certificate of origin. As will be discussed in more detail below, the indicator 182 of the exemplary embodiment is configured to allow an employee of the shipping service provider to quickly recognize that the parcel shipment includes associated electronic customs documentation. As will be understood by those skilled in the art, the shipping label 150 is not limited to the format described above. The information included in the format described above may be rearranged, deleted, or added to create labels of different configurations.

Returning to FIG. 4, in block 110 the shipping entity transmits a file containing the electronic shipping invoice to a third party data validator (41 in FIG. 1). In the exemplary embodiment, the filename used for the file containing the electronic shipping invoice incorporates the tracking number (or a portion of the tracking number) of the parcel shipment. As a result, the filename may quickly be associated with the parcel shipment. Additionally, the filename may be searched using the unique tracking number. In the exemplary embodiment, the third party data validator 41 reviews the electronic shipping invoice to verify that all of the required data is included and that electronic shipping invoice is readable (e.g., the data included in the invoice is legible, etc.). Once the third party data validator 41 has verified the electronic shipping invoice, the third party data validator 41 transmits the electronic file containing the electronic shipping invoice to the origin distribution center (42 in FIG. 1). It should be noted that although the exemplary embodiment includes a third party data validator 41, in other embodiments a third party data validator 41 need not be included, as the electronic shipping invoice may be forwarded to the origin distribution center 42 by the shipping service provider 20 or by the shipping entity 32.

In block 114, the package is delivered to the origin distribution center 42. Under prior art practices, when the package first arrives at a distribution center, an employee typically performs a six-sided search for the shipping label so that the human readable portions of the label may be read by the employee (or the machine readable portions may be read by a scanner). As noted above, under prior art practices the employee (or another employee) also searches for a paper copy of the shipping invoice attached to the package so that it may be audited. In the exemplary embodiment of the present invention, parcel shipments that include electronic shipping invoices have shipping labels displaying an electronic invoice indicator 182 as shown by example in FIG. 5. In block 116, by locating and noting that a package has a shipping label displaying the electronic invoice indicator (182 in FIG. 5), an employee will recognize that the package should not include a paper copy of the shipping invoice, and thus the employee need not search for one. In block 118, if needed, the employee (or another employee) may retrieve the electronic file containing the electronic shipping invoice. In one embodiment, this may be accomplished by searching a database associated with the origin distribution center for the file containing the electronic shipping invoice using the tracking number (or a portion of the tracking number). It should be noted that although the exemplary embodiment describes retrieving the electronic shipping invoice that has been transmitted over a network, in other embodiments of the present invention, a copy of the electronic shipping invoice may be stored on the shipping label, such as for example, an embodiment in which the electronic shipping invoice may be encoded into an RFID transponder associated with the parcel shipment. It should also be noted that to avoid confusion, if an employee at the distribution center notices that there is both an electronic indicator 182 on the shipping label, and a paper shipping invoice attached to one or more packages of the parcel shipment, the employee may remove the paper copy of the invoice consistent with an agreement with the shipping entity that for those countries that accept electronic customs documentation, an electronic invoice will take precedence over a paper invoice.

In block 120 of the exemplary embodiment, the electronic shipping invoice is validated by the employee and transmitted to a document repository (40 in FIG. 1). After validating the electronic invoice, in block 122, the parcel shipment is delivered to a customs office of the destination county. Because the parcel shipment is destined for a country that accepts electronic customs documentation, an electronic copy of the invoice may be accessed from the document repository 40 for review by importing agents or a customs broker. Alternatively, if the electronic shipping invoice is encoded in an RFID transponder associated with the parcel shipment, such as being encoded into an RFID transponder (169 in FIG. 5) attached to the label 150, the invoice may be accessed from the package. It should be noted that in other embodiments, the electronic shipping invoice need not be transmitted to a document repository as the electronic invoice may be located at the shipping entity system 32 or shipping service provider server 20 and accessed through the network 30.

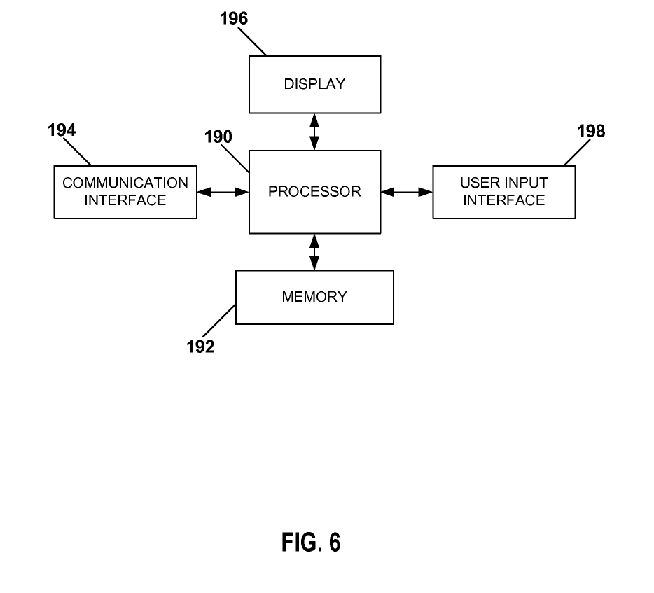

The foregoing merely illustrates how exemplary embodiments of the present invention provide paperless customs documentation by storing shipping data, verifying a destination country accepts electronic customs documentation, and creating an electronic invoice from the shipping data. Referring now to FIG. 6 a block diagram of an exemplary electronic device (e.g., PC, laptop, PDA, etc.) configured to execute the method of providing paperless customs documentation associated with an international parcel shipment of the present invention is shown. The electronic device may include various means for performing one or more functions in accordance with exemplary embodiments of the present invention, including those more particularly shown and described herein. It should be understood, however, that the electronic device may include alternative means for performing one or more like functions, without departing from the spirit and scope of the present invention. As shown, the electronic device may generally include means, such as a processor, controller, or the like 190 connected to a memory 192, for performing or controlling the various functions of the entity.

The memory can comprise volatile and/or non-volatile memory, and typically stores content, data or the like. For example, the memory typically stores content transmitted from, and/or received by, the electronic device. Also for example, the memory typically stores software applications, instructions or the like for the processor to perform steps associated with operation of the electronic device in accordance with embodiments of the present invention. In particular, the memory 192 may store computer program code for an application and other computer programs. For example, in one exemplary embodiment of the present invention, the memory may store computer program code for, among other things, storing shipping data associated with a parcel shipment, the shipping data designating a destination country and including invoice data, verifying that the destination country accepts electronic customs documentation, and creating an electronic invoice from the shipping data.

In addition to the memory 192, the processor 190 can also be connected to at least one interface or other means for displaying, transmitting and/or receiving data, content or the like. In this regard, the interface(s) can include at least one communication interface 194 or other means for transmitting and/or receiving data, content or the like, as well as at least one user interface that can include a display 196 and/or a user input interface 198. The user input interface, in turn, can comprise any of a number of devices allowing the electronic device to receive data from a user, such as a keypad, a touch display, a joystick or other input device.

As described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product consisting of a computer-readable storage medium (e.g., the memory 192 in FIG. 6) and computer-readable program instructions (e.g., computer software) stored in the storage medium. Any suitable computer-readable storage medium may be utilized including hard disks, CD-ROMs, optical storage devices, or magnetic storage devices.

Exemplary embodiments of the present invention have been described above with reference to block diagrams or flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing paperless customs documentation associated with an international parcel shipment, said method comprising:
storing shipping data provided by a shipping entity and associated with the parcel shipment, the shipping data designating a destination country and including invoice data;
verifying that the destination country accepts electronic customs documentation; and
creating an electronic invoice from the shipping data.

2. The method of claim 1, further comprising transferring the electronic invoice over a network to a distribution center.

3. The method of claim 1, further comprising creating a reference number associated with the parcel shipment.

4. The method of claim 1, further comprising transferring the electronic invoice over a network to a third party, wherein the third party validates the electronic invoice.

5. The method of claim 1, wherein the step of creating an electronic invoice comprises transferring the shipping data over a network to a shipping service provider and wherein the shipping service provider coverts the shipping data into the electronic invoice.

6. The method of claim 1, wherein the step of creating an electronic invoice comprises transferring the shipping data over a network to a third party, and wherein the third party converts the shipping data into the electronic invoice.

7. The method of claim 1, further comprising storing the electronic invoice on a database accessible over the network.

8. The method of claim 2, further comprising creating an electronic record that includes an image of the electronic invoice, the electronic record having an associated filename that incorporates at least a portion of the reference number, and wherein the step of transferring the electronic invoice comprises transferring the electronic record.

9. The method of claim 1, further comprising generating a printed label associated with the parcel shipment.

10. The method of claim 9, wherein the printed label includes a readable indicator indicating that an electronic invoice is associated with the international parcel shipment.

11. The method of claim 10, wherein the readable indicator is a visual indicator.

12. The method of claim 10, wherein the readable indicator is a machine readable indicator.

13. The method of claim 12, wherein the machine readable indicator is readable by at least one of barcode reader, a MaxiCode reader, a PDF417 reader, or an RFID reader.

14. The method of claim 1, wherein the electronic invoice is stored in an RFID transponder associated with the parcel shipment.

15. A method of providing paperless customs documentation associated with an international parcel shipment, said method comprising:
storing shipping data associated with the parcel shipment, the shipping data designating a destination country and including invoice data;
creating a reference number associated with the parcel shipment;
verifying that the destination country accepts electronic customs documentation;
creating an electronic invoice from the shipping data;
creating an electronic record that includes an image of the electronic invoice, the electronic record having an associated filename that incorporates at least a portion of the reference number;
generating a printed label associated with the parcel shipment, wherein the printed label includes a readable indicator indicating that an electronic invoice is associated with the international parcel shipment;
transferring the electronic record over a network to a third party, wherein the third party validates the electronic invoice; and
transferring the electronic record over a network to a distribution center.

16. A computer program product for providing paperless customs documentation associated with an international parcel shipment, wherein the computer program product comprises at least one computer-readable storage medium having computer-readable program code portions stored therein, the computer-readable program code portions comprising:
a first executable portion for storing shipping data provided by a shipping entity and associated with the parcel shipment, the shipping data designating a destination country and including invoice data;
a second executable portion for verifying that the destination country accepts electronic customs documentation; and
a third executable portion for creating an electronic invoice from the shipping data; and

17. The computer program product of claim 16, further comprising a fourth executable portion for transferring the electronic invoice over a network to a distribution center.

18. The computer program product of claim 16, further comprising a fourth executable portion for creating a reference number associated with the parcel shipment.

19. The computer program product of claim 16, further comprising a fourth executable portion for transferring the electronic invoice over a network to a third party, wherein the third party validates the electronic invoice.

20. The computer program product of claim 16, wherein the third executable portion comprises an executable portion for transferring the shipping data over a network to a shipping service provider and wherein the shipping service provider coverts the shipping data into the electronic invoice.

21. The computer program product of claim 16, wherein the third executable portion comprises an executable portion for transferring the shipping data over a network to a third party, and wherein the third party converts the shipping data into the electronic invoice.

22. The computer program product of claim 16, further comprising a fourth executable portion for storing the electronic invoice on a database accessible over the network.

23. The computer program product of claim 17, further comprising a fifth executable portion for creating an electronic record that includes an image of the electronic invoice, the electronic record having an associated filename that incorporates at least a portion of the reference number, and wherein the fourth executable portion comprises an executable portion for transferring the electronic record.

24. The computer program product of claim 16, further comprising a fourth executable portion for generating a printed label associated with the parcel shipment.

25. The computer program product of claim 24, wherein the printed label includes a readable indicator indicating that an electronic invoice is associated with the international parcel shipment.

26. The computer program product of claim 25, wherein the readable indicator is a visual indicator.

27. The computer program product of claim 25, wherein the readable indicator is a machine readable indicator.

28. The computer program product of claim 27, wherein the machine readable indicator is readable by at least one of barcode reader, a MaxiCode reader, a PDF417 reader, or an RFID reader.

29. The computer program product of claim 16, wherein the electronic invoice is stored in an RFID transponder associated with the parcel shipment.

30. A computer program product for providing paperless customs documentation associated with an international parcel shipment, wherein the computer program product comprises at least one computer-readable storage medium having computer-readable program code portions stored therein, the computer-readable program code portions comprising:
a first executable portion for storing shipping data provided by a shipping entity and associated with the parcel shipment, the shipping data designating a destination country and including invoice data;
a second executable portion for storing shipping data provided by a shipping entity and associated with the parcel shipment, the shipping data designating a destination country and including invoice data;
a third executable portion for creating a reference number associated with the parcel shipment;
a fourth executable portion for verifying that the destination country accepts electronic customs documentation;
a fifth executable portion for creating an electronic invoice from the shipping data;
a sixth executable portion for creating an electronic record that includes an image of the electronic invoice, the electronic record having an associated filename that incorporates at least a portion of the reference number;
a seventh executable portion generating a printed label associated with the parcel shipment, wherein the printed label includes a readable indicator indicating that an electronic invoice is associated with the international parcel shipment;
an eighth executable portion for transferring the electronic record over a network to a third party, wherein the third party validates the electronic invoice; and
a ninth executable portion for transferring the electronic record over a network to a distribution center.
